(19) United States
(12) Patent Application Publication
(10) Pub. No.: US 2023/0135473 A1
(43) Pub. Date: May 4, 2023

(54) NATIVE BUILDING AND MINTING OF NON-FUNGIBLE TOKENS ON A BLOCKCHAIN

(71) Applicant: Meta Platforms, Inc., Menlo Park, CA (US)

(72) Inventors: Adeniyi Emmanuel Abiodun, San Jose, CA (US); Konstantinos Chalkias, Menlo Park, CA (US); Evan Cheng, Hillsborough, CA (US); Samuel Howard Blackshear, San Francisco, CA (US); Avery Li Kuang Ching, Cupertino, CA (US)

(21) Appl. No.: 17/518,456

(22) Filed: Nov. 3, 2021

(30) Foreign Application Priority Data
Oct. 29, 2021 (GR) 20210100744

(51) Int. Cl. G06F 21/10; G06F 21/60; G06Q 30/08

(52) U.S. Cl. CPC G06F 21/10; G06F 21/602; G06Q 30/08; G06F 2221/0713

(57) ABSTRACT

Methods, systems, and storage media for minting a digital collectible are disclosed. Exemplary implementations may: receive a request from a user to generate a digital collectible comprising user-created content; validate the user-created content was created by the user; receive a designation of a number of copies of the digital collectible that are to be generated; generate the digital collectible based on the user-created content; and record the digital collectible to a blockchain.

### TECHNICAL FIELD

The present disclosure generally relates to minting a digital collectible, and more particularly to native building and minting of non-fungible tokens on a blockchain.

### BACKGROUND

Conventionally, a non-fungible token (NFT) may include a unit of data stored on a digital ledger (e.g., a blockchain). NFTs may represent a variety of digital assets including photos, videos, audio, and other digital assets. NFTs can be sold and traded. Access to the digital asset is not restricted to the NFT owner. Rather, NFTs are tracked on digital ledgers to provide a proof of ownership separate from copyright.

### BRIEF SUMMARY

The subject disclosure provides for systems and methods for minting a digital collectible. A user is allowed to own and profit from content they create and share via social media platforms. For example, when a user posts content they created, they may optionally convert that user-created content to a digital collectible (e.g., NFT), which may be sold or traded with other users and/or transferred outside of the social media platform.

One aspect of the present disclosure relates to a method for minting a digital collectible. The method may include receiving a request from a user to generate a digital collectible including user-created content. The method may include validating the user-created content was created by the user. The method may include receiving a designation of a number of copies of the digital collectible that are to be generated. The method may include generating the digital collectible based on the user-created content. The method may include recording the digital collectible to a blockchain.

Another aspect of the present disclosure relates to a system configured for minting a digital collectible. The system may include one or more hardware processors configured by machine-readable instructions. The processor(s) may be configured to receive a request from a user to generate a digital collectible comprising user-created content. The request may be received in connection with a user posting the user-created content to a feed of a social media platform. The processor(s) may be configured to validate the user-created content was created by the user. The processor(s) may be configured to receive a designation of a number of copies of the digital collectible that are to be generated. The processor(s) may be configured to generate the digital collectible based on the user-created content. The digital collectible may include a non-fungible token. The processor(s) may be configured to record the digital collectible to a blockchain.

Yet another aspect of the present disclosure relates to a non-transient computer-readable storage medium having instructions embodied thereon, the instructions being executable by one or more processors to perform a method for minting a digital collectible. The method may include receiving a request from a user to generate a digital collectible comprising user-created content. The request may be received in connection with a user posting the user-created content to a feed of a social media platform. The method may include validating the user-created content was created by the user. The validating may include a digital rights management (DRM) process. Responsive to the user-created content being determined to actually be third-party content protected through DRM, the third-party content may be prevented from being posted on the social media platform and a digital collectible for the third-party content may not be minted. The method may include receiving a designation of a number of copies of the digital collectible that are to be generated. The method may include generating the digital collectible based on the user-created content. The digital collectible may include a non-fungible token. The digital collectible may be transferrable between users. The method may include recording the digital collectible to a blockchain. The blockchain may be used for recording ownership of non-fungible tokens and not for facilitating monetary transactions. The method may include auctioning the digital collectible to a plurality of other users. The method may include causing display of the digital collectible in a user profile associated with one of the plurality of other users.

Still another aspect of the present disclosure relates to a system configured for minting a digital collectible. The system may include means for receiving a request from a user to generate a digital collectible including user-created content. The system may include means for validating the user-created content was created by the user. The system may include means for receiving a designation of a number of copies of the digital collectible that are to be generated. The system may include means for generating the digital collectible based on the user-created content. The system may include means for recording the digital collectible to a blockchain.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example environment in which aspects of the disclosure may be practiced.

FIG. 2 illustrates an example flow diagram for native building and minting of non-fungible tokens on a blockchain, according to certain aspects of the disclosure.

FIG. 3 illustrates a system configured for minting a digital collectible, in accordance with one or more implementations.

FIG. 4 illustrates an example flow diagram for minting a digital collectible, according to certain aspects of the disclosure.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

A central feature of social media platforms is the ability for users to create content and share that content with other users of the social media platform, such as by posting the user-created content to their feed. Social medial platform users may wish to establish ownership of their user-created content, separate from copyright. Moreover, the users may wish to monetize their user-created content. Present approaches for establishing ownership of and monetizing content created by users on social media platforms is inefficient, not cohesive, and not user friendly.

The subject disclosure provides for systems and methods for minting a digital collectible. A user is allowed to own and profit from content they create and share via social media platforms. For example, when a user posts content they created, they may optionally convert that user-created content to a digital collectible (e.g., NFT), which may be sold or traded with other users and/or transferred outside of the social media platform.

Implementations described herein address these and other shortcomings by providing a public permissioned, blockchain network that stores tokenized digital content (e.g., NFTs), but settles transactions on a separate payment network. Minting of the NFTs may occur during a process for posting user-created content to a feed of a social media platform. Exemplary implementations may be interoperable with other public and private blockchains enabling assets to move freely between diverse wallets and blockchain platforms. Some implementations may be compatible with open standards (e.g., Diem, IPFS, Web3, etc.).

Exemplary implementations may provide a simple global payment system and financial infrastructure that empowers billions of people to own, transfer, and profit from content they create across all digital platforms. This may be achieved through an open, interoperable, low-cost infrastructure that is accessible to anyone with a cellphone and empowers developers to build innovative new financial services. Some implementations offer NFTs seamlessly across a family of social media platforms, fully benefiting from the speed, safety and low-cost afforded by blockchain technology.

According to some implementations, NFTs may be created and shared across multiple social media platforms and/or other platforms. Users may use a digital wallet configured to hold a plurality of different digital assets including NFTs and cryptocurrencies. Content creators may be enabled to mint NFTs via one or more of the multiple social media platforms. NFTs may be stored on a blockchain such that ownership is publicly verifiable. Ownership of an NFT may be assigned to a content creator's digital wallet. NFT ownership may be directly transferred between different wallets and/or different blockchains. Exemplary embodiments may offer content creators a transparent and flexible monetization strategy.

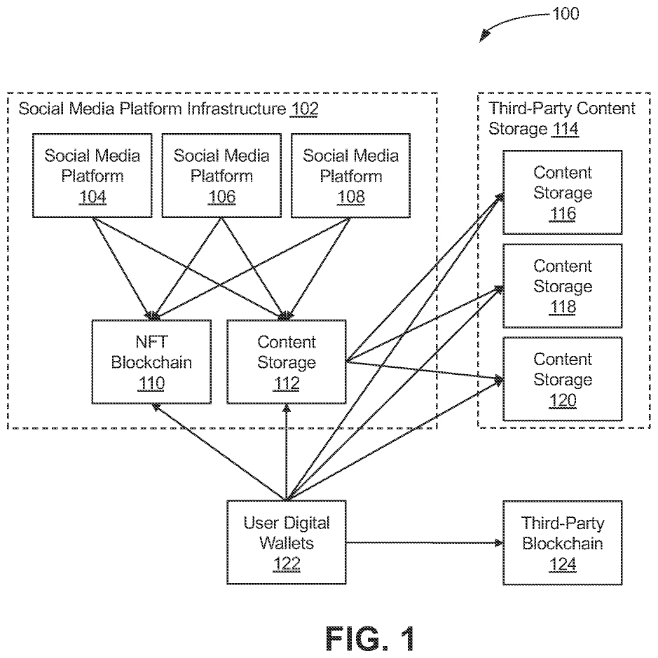

FIG. 1 illustrates an example environment 100 in which aspects of the disclosure may be practiced. As illustrated in FIG. 1, environment 100 may include a social media platform infrastructure 102 configured to support one or more social medial platforms (e.g., social media platform 104, social media platform 106, and social media platform 108). The social media platforms 104, 106, and 108 may enable users to post content they created in their feeds on the respective platforms. NFT blockchain 110 and content storage 112 may be utilized by a plurality of entities within the social media platform infrastructure 102 (e.g., social media platforms 104, 106, and 108).

During a posting process, a user may be able to indicate whether they would like to make their content an NFT. If they do, their ownership of their user-created content may be recorded on NFT blockchain 110 as an NFT. Recording on the NFT blockchain 110 may include generating metadata and/or data for the user-created content to be tokenized and persist. As an issuer of NFTs, the NFT blockchain 110 may generated secure hash of metadata and/or data and issue the NFT owned by the user. The NFT blockchain 110 may facilitate public accessibility of individual unique identities of NFTs. The NFT blockchain 110 may be trustable and able to interface and/or exchange with other NFT based protocols and/or systems.

The user-created content itself, however, may be stored by content storage 112. Alternatively, or additionally, the user-created content may be stored by third-party content storage 114 (e.g., content storage 116, content storage 118, and content storage 120). As such, storage of the user-created content that an NFT is identifying can be decoupled from NFT ownership storage since it needs to only be fault-tolerant and accessible to the requirements of the NFT owner and can vary depending on the NFT itself. In some implementations, some NFTs could initially be private and then made publicly available later.

According to some implementations, users may use their user digital wallets 122 to have their NFTs custodied. In some implementations, unhosted wallets may be available to users. User digital wallets 122 may be configured to access a supported payment mechanism. User digital wallets 122 may be configured to monetize the NFTs. For example, a given user digital wallet 122 may be configured to list NFTs for sale by the associated user and conduct an action via the given user digital wallet 122 itself. In some implementations, user digital wallets 122 may be configured to facilitate interoperable auctions on behalf of the user (e.g., auctions conducted on the NFT blockchain 110). Exemplary implementations may facilitate querying NFT blockchain 110 to verify NFT ownership and transfers. Some implementations may facilitate initiating an NFT transfer from one user to another by creating the transactions on NFT blockchain 110. Some implementations may facilitate initiating a coin transfer of NFT from one user to another by submitting transactions to a third-party blockchain 124 (e.g., Bitcoin blockchain, Ethereum blockchain, etc.) to facilitate an atomic swap. An atomic swap may include automatic exchange contracts allowing two users to trade tokens from two different blockchains. Exemplary implementations may facilitate selling and/or purchasing of NFTs between users via atomic swaps with the NFT blockchain 110.

Exemplary implementations provide authenticity though immutable proof of origin and/or ownership enabled by NFT blockchain 110. This may bring increased confidence for copyright owners to bring their assets into environments like virtual reality and augmented reality by enabling “official” virtual objects which can be independently verified as legitimately owned intellectual property. For doing business in such environments, exemplary implementations may facilitate improved access to selling and/or transfer of digital assets (e.g., tools). Transparent transactions may enable emerging content creators to manage their business, negotiate fair deals, and decrease cost of business for both builders and buyers of augmented reality and virtual objects. In some implementations, NFT blockchain 110 may be configured to preserve attribution and recognition of user-created content, even if the user-created content is combined and/or remixed into a new effect and/or virtual object.

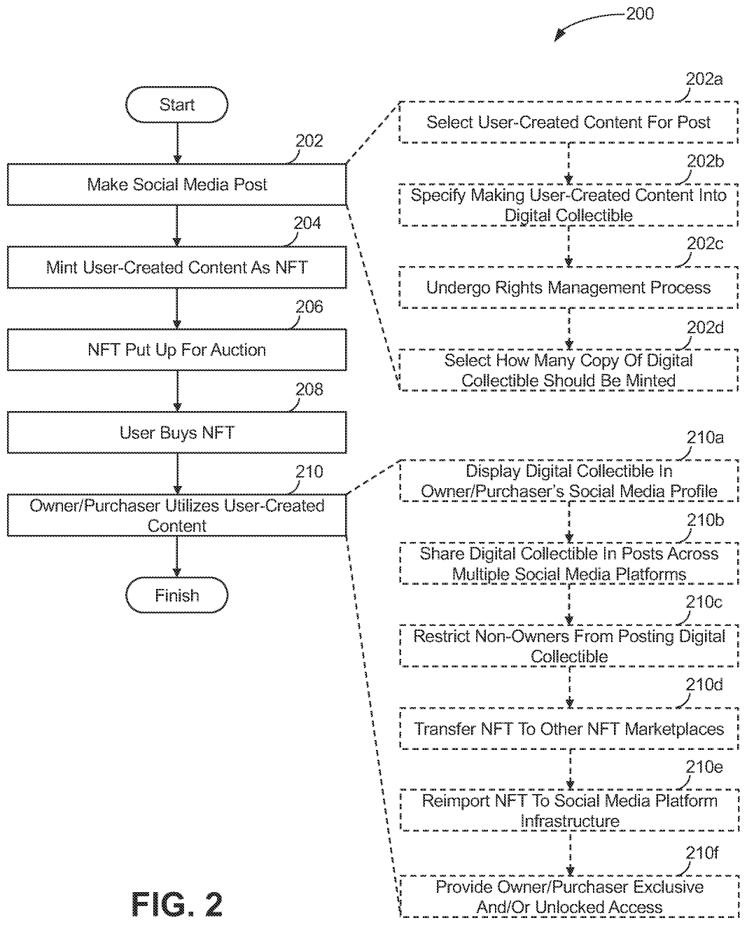

FIG. 2 illustrates an example flow diagram 200 for native building and minting of non-fungible tokens on a blockchain, according to certain aspects of the disclosure. According to some implementations, native building and minting of NFTs may enable content creators to post their own user-created content on a social media feed of a social media platform (e.g., social media platforms 104, 106, and/or 108 in FIG. 1) (step 202), mint the user-created content as an NFT (step 204), put the NFT up for auction (step 206), have a user (e.g., a fan) buy it (step 208) so the user can utilize the user-created content (step 210), for example, display the content associated with the NFT in their profile, share the content, sell the content, trade the content, and/or utilize the user-created content in other ways.

To illustrate, and by way of non-limiting example, if a content creator on a given social media platform is making a post (step 202a), they may specify making their user-created content a digital collectible (e.g., an NFT) (step 202b). The user-created content may undergo a rights managing process (step 202c), e.g., to screen for copyright violations. Once verified, the user may receive a form of guarantee the user-created content belongs to the content creator by way of the NFT. The user may provide a selection as to how many copies (step 202d) of the to-be-minted NFT are desired (e.g., 100 fans out of 1000 superfans can own this digital collectible). Once minted, the NFTs may go on an auction (see step 206) such that a certain number of top bids (e.g., top 100 bids) will own the NFTs. After the NFTs are minted, the user-created content may rest in profiles of the owners/purchasers (step 210a) and only the owners/purchasers may share the digital collectible (step 210b) across one or more social media platforms (e.g., social media platforms 104, 106, and/or 108 in FIG. 1). If a non-owner attempts to post the user-created content, the social media platform may restrict the non-owner from doing so (step 210c). The owners/purchasers may transfer their NFTs to other NFT marketplaces (step 210d). The owners/purchasers may later re-import the NFTs (step 210e) to the social media platform infrastructure 102. Some NFTs may provide their owners with exclusive and/or unlocked access (step 210f) to certain groups or other aspects of a social media platform or other environments.

The disclosed system(s) address a problem in traditional digital collectible minting techniques tied to computer technology, namely, the technical problem of allowing content creators on social media platforms to verify their ownership of the content they create and monetize that content. The disclosed system solves this technical problem by providing a solution also rooted in computer technology, namely, by providing for native building and minting of non-fungible tokens on a blockchain. The disclosed subject technology further provides improvements to the functioning of the computer itself because it improves processing and efficiency in minting a digital collectible.

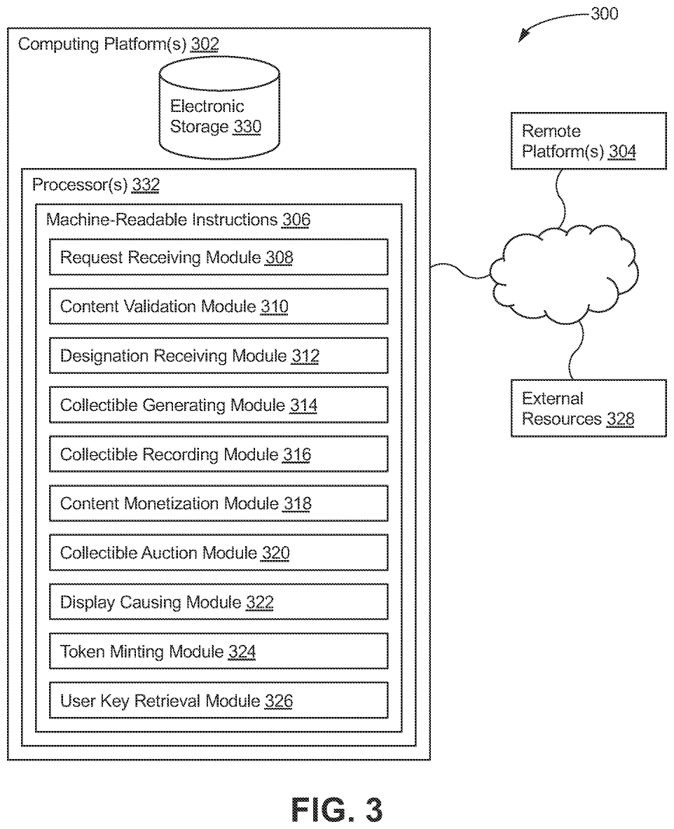

FIG. 3 illustrates a system 300 configured for minting a digital collectible, according to certain aspects of the disclosure. In some implementations, system 300 may include one or more computing platforms 302. Computing platform(s) 302 may be configured to communicate with one or more remote platforms 304 according to a client/server architecture, a peer-to-peer architecture, and/or other architectures. Remote platform(s) 304 may be configured to communicate with other remote platforms via computing platform(s) 302 and/or according to a client/server architecture, a peer-to-peer architecture, and/or other architectures. Users may access system 300 via remote platform(s) 304.

Computing platform(s) 302 may be configured by machine-readable instructions 306. Machine-readable instructions 306 may include one or more instruction modules. The instruction modules may include computer program modules. The instruction modules may include one or more of request receiving module 308, content validation module 310, designation receiving module 312, collectible generating module 314, collectible recording module 316, content monetization module 318, collectible auction module 320, display causing module 322, token minting module 324, user key retrieval module 326, and/or other instruction modules.

Request receiving module 308 may be configured to receive a request from a user to generate a digital collectible including user-created content. By way of non-limiting example, the user-created content may include one or more of a post to a feed, an image, a video, a message, or text. The digital collectible may be generated within a social media platform. In some implementations, ownership of specific collectibles may grant exclusive access to certain users. The digital collectible may be transferrable between users. The digital collectible may be created within a social media platform and is transferrable outside of the social media platform. The request may be received as part of a process for posting the user-created content to a user feed within the social media platform.

Content validation module 310 may be configured to validate the user-created content was created by the user. Validating the user-created content was created by the user may include determining a copyright of the user-created content. The validating may include a digital rights management (DRM) process. By way of non-limiting example, the DRM process may include determining and/or controlling one or more of use, modification, or distribution of copyrighted works. DRM may include one or more access control techniques and/or technologies for restricting the use of proprietary copyrighted works. In implementing DRM, publishers may encrypt and/or scramble copyrighted material and/or embed a tag in a digital copy of the copyrighted material. As such, publishers may be enabled to enforce their own access policies on content, such as restrictions on copying, viewing, or posting. Responsive to content validation module 310 detecting and/or determining that the alleged user-created content is actually third-party content protected through DRM, the third-party content may be prevented from being posted on the social media platform and a digital collectible for the third-party content may not be minted.

Designation receiving module 312 may be configured to receive a designation of a number of copies of the digital collectible that are to be generated. The user may select how many copies of the digital collectible should be created. The number of copies may include a number between 1 and 100, between 101 and 1000, between 1001 and 10000, or more than 10000. The designation may limit access to the digital collectible to only a subset of other users of a social media platform. By way of non-limiting example, the subset of other users may include superfans of the user, a given superfan including another user that meets a set of relationship criteria with the user. By way of non-limiting example, the set of relationship criteria may relate to one or more of social media connections, feed subscribers, followers, friends, connections in common, user-specified content preferences, or predicted content preferences.

Collectible generating module 314 may be configured to generate the digital collectible based on the user-created content. The digital collectible may include a non-fungible token. Collectible recording module 316 may be configured to record the digital collectible to a blockchain.

Content monetization module 318 may be configured to monetize the user-created content. Monetizing the user-created content may include facilitating a transaction that occurs separate and outside of the blockchain. The transaction may occur on a payment network that is separate and distinct from the blockchain. The transaction may include a wallet-to-wallet transaction between two users. The transaction may be supported by a plurality of different digital currencies. To discover a value of the digital collectible, an action may be used.

Collectible auction module 320 may be configured to auction the digital collectible. The user may select when an action of the digital collectible should start. In some implementations, the user may select a starting price for bidding. Auctioning the digital collectible may determine a value of the digital collectible. Auctioning the digital collectible may include accepting bids that exceed a user-defined minimum bid. Auctioning the digital collectible may include accepting a number of top bids as auction winners. The number of top bids may equal a number of digital collectibles being minted.

Display causing module 322 may be configured to cause display of the digital collectible in a user profile. If validating the user-created content created by and/or owned by a given user is negative, then the user-created content may be blocked from being posted to the feed within the social media platform by that user.

Token minting module 324 may be configured to mint digital tokens based on the digital collectible. The digital collectible may include a non-fungible token.

User key retrieval module 326 may be configured to retrieve lost user keys to the users. Retrieving of lost user keys to the users may be facilitated by a key management system that is separate and distinct from the blockchain. In some implementations, retrieving of lost user keys to the users may include recovering lost keys. In some implementations, retrieving of lost user keys to the users may include receiving evidence that the user lost their key. In some implementations, retrieving of lost user keys to the users may include receiving a challenge from another user as to whether the user is a true owner of the lost key.

In some implementations, computing platform(s) 302, remote platform(s) 304, and/or external resources 328 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 302, remote platform(s) 304, and/or external resources 328 may be operatively linked via some other communication media.

A given remote platform 304 may include one or more processors configured to execute computer program modules. The computer program modules may be configured to enable an expert or user associated with the given remote platform 304 to interface with system 300 and/or external resources 328, and/or provide other functionality attributed herein to remote platform(s) 304. By way of non-limiting example, a given remote platform 304 and/or a given computing platform 302 may include one or more of a server, a desktop computer, a laptop computer, a handheld computer, a tablet computing platform, a NetBook, a Smartphone, a gaming console, and/or other computing platforms.

External resources 328 may include sources of information outside of system 300, external entities participating with system 300, and/or other resources. In some implementations, some or all of the functionality attributed herein to external resources 328 may be provided by resources included in system 300.

Computing platform(s) 302 may include electronic storage 330, one or more processors 332, and/or other components. Computing platform(s) 302 may include communication lines, or ports to enable the exchange of information with a network and/or other computing platforms. Illustration of computing platform(s) 302 in FIG. 3 is not intended to be limiting. Computing platform(s) 302 may include a plurality of hardware, software, and/or firmware components operating together to provide the functionality attributed herein to computing platform(s) 302. For example, computing platform(s) 302 may be implemented by a cloud of computing platforms operating together as computing platform(s) 302.

Electronic storage 330 may comprise non-transitory storage media that electronically stores information. The electronic storage media of electronic storage 330 may include one or both of system storage that is provided integrally (i.e., substantially non-removable) with computing platform(s) 302 and/or removable storage that is removably connectable to computing platform(s) 302 via, for example, a port (e.g., a USB port, a firewire port, etc.) or a drive (e.g., a disk drive, etc.). Electronic storage 330 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 330 may include one or more virtual storage resources (e.g., cloud storage, a virtual private network, and/or other virtual storage resources). Electronic storage 330 may store software algorithms, information determined by processor(s) 332, information received from computing platform(s) 302, information received from remote platform(s) 304, and/or other information that enables computing platform(s) 302 to function as described herein.

Processor(s) 332 may be configured to provide information processing capabilities in computing platform(s) 302. As such, processor(s) 332 may include one or more of a digital processor, an analog processor, a digital circuit designed to process information, an analog circuit designed to process information, a state machine, and/or other mechanisms for electronically processing information. Although processor(s) 332 is shown in FIG. 3 as a single entity, this is for illustrative purposes only. In some implementations, processor(s) 332 may include a plurality of processing units. These processing units may be physically located within the same device, or processor(s) 332 may represent processing functionality of a plurality of devices operating in coordination. Processor(s) 332 may be configured to execute modules 308, 310, 312, 314, 316, 318, 320, 322, 324, and/or 326, and/or other modules. Processor(s) 332 may be configured to execute modules 308, 310, 312, 314, 316, 318, 320, 322, 324, and/or 326, and/or other modules by software; hardware; firmware; some combination of software, hardware, and/or firmware; and/or other mechanisms for configuring processing capabilities on processor(s) 332. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 308, 310, 312, 314, 316, 318, 320, 322, 324, and/or 326 are illustrated in FIG. 3 as being implemented within a single processing unit, in implementations in which processor(s) 332 includes multiple processing units, one or more of modules 308, 310, 312, 314, 316, 318, 320, 322, 324, and/or 326 may be implemented remotely from the other modules. The description of the functionality provided by the different modules 308, 310, 312, 314, 316, 318, 320, 322, 324, and/or 326 described below is for illustrative purposes, and is not intended to be limiting, as any of modules 308, 310, 312, 314, 316, 318, 320, 322, 324, and/or 326 may provide more or less functionality than is described. For example, one or more of modules 308, 310, 312, 314, 316, 318, 320, 322, 324, and/or 326 may be eliminated, and some or all of its functionality may be provided by other ones of modules 308, 310, 312, 314, 316, 318, 320, 322, 324, and/or 326. As another example, processor(s) 332 may be configured to execute one or more additional modules that may perform some or all of the functionality attributed below to one of modules 308, 310, 312, 314, 316, 318, 320, 322, 324, and/or 326.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

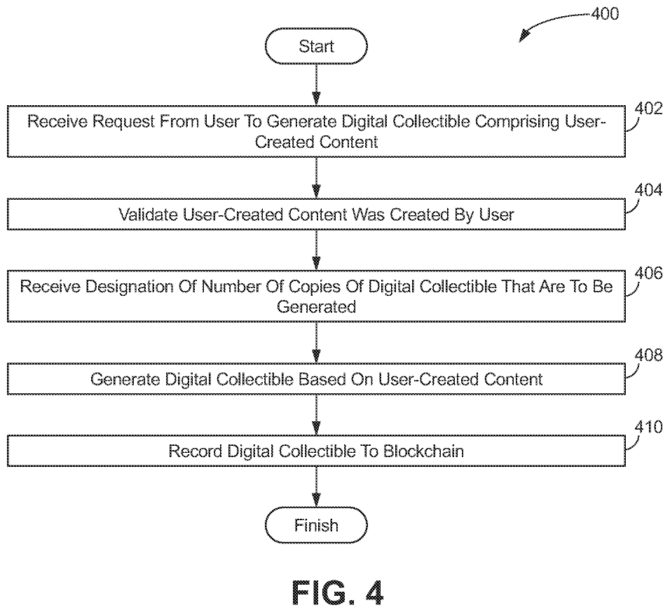

FIG. 4 illustrates an example flow diagram (e.g., process 400) for minting a digital collectible, according to certain aspects of the disclosure. For explanatory purposes, the example process 400 is described herein with reference to FIGS. 1-3. Further for explanatory purposes, the steps of the example process 400 are described herein as occurring in serial, or linearly. However, multiple instances of the example process 400 may occur in parallel. For purposes of explanation of the subject technology, the process 400 will be discussed in reference to FIGS. 1-3.

At step 402, the process 400 may include receiving a request from a user to generate a digital collectible including user-created content. At step 404, the process 400 may include validating the user-created content was created by the user. At step 406, the process 400 may include receiving a designation of a number of copies of the digital collectible that are to be generated. At step 408, the process 400 may include generating the digital collectible based on the user-created content. At step 410, the process 400 may include recording the digital collectible to a blockchain.

For example, as described above in relation to FIGS. 1-3, at step 402, the process 400 may include receiving a request from a user to generate a digital collectible including user-created content, through request receiving module 308. At step 404, the process 400 may include validating the user-created content was created by the user, through content validation module 310. At step 406, the process 400 may include receiving a designation of a number of copies of the digital collectible that are to be generated, through designation receiving module 312. At step 408, the process 400 may include generating the digital collectible based on the user-created content, through collectible generating module 314. At step 410, the process 400 may include recording the digital collectible to a blockchain, through collectible recording module 316.

According to an aspect, the digital collectible comprises a non-fungible token (NFT).

According to an aspect, the user-created content comprises one or more of a post to a feed, an image, a video, a message, or text.

According to an aspect, the process 400 further includes monetizing the user-created content.

According to an aspect, the validating comprises a digital rights management (DRM) process.

According to an aspect, the number of copies includes a number between 1 and 100, between 101 and 1000, between 1001 and 10000, or more than 10000.

According to an aspect, the designation limits access to the digital collectible to only a subset of other users of a social media platform.

According to an aspect, the process 400 further includes auctioning the digital collectible.

According to an aspect, the process 400 further includes causing display of the digital collectible in a user profile.

According to an aspect, the digital collectible is transferrable between users.

According to an aspect, the process 400 further includes minting digital tokens based on the digital collectible.

According to an aspect, ownership of specific collectibles grants exclusive access to certain users.

According to an aspect, the process 400 further includes retrieving of lost user keys to the users.

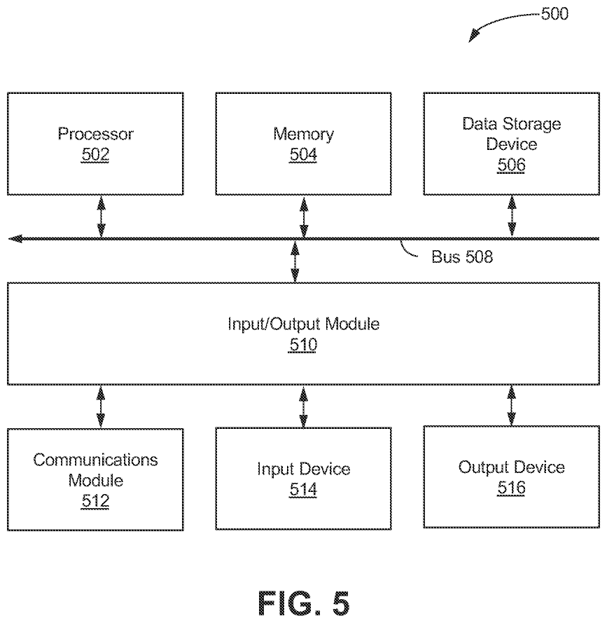

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for minting a digital collectible, comprising:
receiving a request from a user to generate a digital collectible comprising user-created content, the request being received in connection with a user posting the user-created content to a feed of a social media platform
validating the user-created content was created by the user;
receiving a designation of a number of copies of the digital collectible that are to be generated;
generating the digital collectible based on the user-created content; and
recording the digital collectible to a blockchain.

2. The computer-implemented method of claim 1, wherein the digital collectible comprises a non-fungible token.

3. The computer-implemented method of claim 1, wherein the user-created content comprises one or more of a post to a feed, an image, a video, a message, or text.

4. The computer-implemented method of claim 1, further comprising:
monetizing the user-created content.

5. The computer-implemented method of claim 1, wherein the validating comprises a digital rights management (DRM) process.

6. The computer-implemented method of claim 1, wherein the number of copies includes a number between 1 and 100, between 101 and 1000, between 1001 and 10000, or more than 10000.

7. The computer-implemented method of claim 1, wherein the designation limits access to the digital collectible to only a subset of other users of a social media platform.

8. The computer-implemented method of claim 1, further comprising:
auctioning the digital collectible.

9. The computer-implemented method of claim 1, further comprising:
causing display of the digital collectible in a user profile.

10. The computer-implemented method of claim 1, wherein the digital collectible is transferrable between users.

11. A system configured for minting a digital collectible, the system comprising:
one or more hardware processors configured by machine-readable instructions to:
receive a request from a user to generate a digital collectible comprising user-created content, the request being received in connection with a user posting the user-created content to a feed of a social media platform;
validate the user-created content was created by the user;
receive a designation of a number of copies of the digital collectible that are to be generated;
generate the digital collectible based on the user-created content, wherein the digital collectible comprises a non-fungible token; and
record the digital collectible to a blockchain.

12. The system of claim 11, wherein the user-created content comprises one or more of a post to a feed, an image, a video, a message, or text.

13. The system of claim 11, wherein the one or more hardware processors are further configured by machine-readable instructions to:
monetize the user-created content.

14. The system of claim 11, wherein the validating comprises a digital rights management (DRM) process.

15. The system of claim 11, wherein the number of copies includes a number between 1 and 100, between 101 and 1000, between 1001 and 10000, or more than 10000.

16. The system of claim 11, wherein the designation limits access to the digital collectible to only a subset of other users of a social media platform.

17. The system of claim 11, wherein the one or more hardware processors are further configured by machine-readable instructions to:
auction the digital collectible.

18. The system of claim 11, wherein the one or more hardware processors are further configured by machine-readable instructions to:
cause display of the digital collectible in a user profile.

19. The system of claim 11, wherein the digital collectible is transferrable between users.

20. A non-transient computer-readable storage medium having instructions embodied thereon, the instructions being executable by one or more processors to perform a method for minting a digital collectible, the method comprising:
receiving a request from a user to generate a digital collectible comprising user-created content, the request being received in connection with a user posting the user-created content to a feed of a social media platform;
validating the user-created content was created by the user, wherein the validating includes a digital rights management (DRM) process, and wherein, responsive to the user-created content being determined to actually be third-party content protected through DRM, the third-party content is prevented from being posted on the social media platform and a digital collectible for the third-party content is not minted;
receiving a designation of a number of copies of the digital collectible that are to be generated;
generating the digital collectible based on the user-created content, wherein the digital collectible comprises a non-fungible token, wherein the digital collectible is transferrable between users;
recording the digital collectible to a blockchain, wherein the blockchain is used for recording ownership of non-fungible tokens and not for facilitating monetary transactions;
auctioning the digital collectible to a plurality of other users; and
causing display of the digital collectible in a user profile associated with one of the plurality of other users.
